(19) United States
(12) Patent Application Publication
(10) Pub. No.: US 2005/0190920 A1
(43) Pub. Date: Sep. 1, 2005

(54) System in a digital wireless data communication network for arranging end-to-end encryption and corresponding terminal equipment

(76) Inventor: Petri Ahonen, Jyvaskyla (FI)

Correspondence Address: HARRINGTON & SMITH, LLP, 4 RESEARCH DRIVE, SHELTON, CT, 06484-6212, US

(21) Appl. No.: 10/511,934

(22) PCT Filed: Apr. 14, 2003
(86) PCT No.: PCT/FI03/00282

§ 371 Date: Oct. 19, 2004

(30) Foreign Application Priority Data
Apr. 23, 2002 (FI) 20025018

(51) Int. Cl. H04L 9/00

(52) U.S. Cl. 380/274; 380/43

(57) ABSTRACT

The invention concerns a system in a digital wireless data communication network for arranging end-to-end encryption in which the data communication network two or more pieces of terminal equipment are communicating with one another, including at least means for management of encryption parameters (TEK, IV), an encryption key stream generator, means for encrypting a dataflow and for decrypting the encryption with the generated key stream segment (KSS, IV), and wherein at least one of the pieces of terminal equipment is adapted to function as a special server terminal device, which manages and distributes encryption parameters and encryption and/or synchronization applications to the other pieces of terminal equipment based on an established criterion and in the terminal equipment are arranged functionalities and means for downloading, saving, managing and carrying out the applications.

The invention concerns a system in a digital wireless data communication network for arranging end-to-end (e2e) encryption, especially for transmission in audio form, in which data communication network two or more pieces of terminal equipment are communicating with one another, wherein at least the following are included
a codec for converting the analog audio signal into a dataflow and vice versa,
air-interface encryption means,
means for managing encryption key parameters stored in connection with the terminal equipment
an encryption key stream generator for generating a key stream segment with the said encryption parameters,
means for encrypting the dataflow and for decrypting the encryption with the generated key stream segment,
means for synchronizing the encrypted dataflow and for de-synchronization, and
at least one interface for receiving the encryption parameters from the data communication network,
   and wherein at least one of the pieces of terminal equipment belonging to the data communication network is adapted to operate as a special server terminal, which manages and distributes at least encryption parameters concerning the data communication network to the other pieces of terminal equipment in accordance with an established criterion. The invention also concerns terminal equipment implementing the system.

TETRA (TErrestrial Trunked RAdio) is a digital, wireless and trunked data communication standard designed especially for groups of demanding professional users. A system according to the TETRA standard, which is called TETRA system hereinafter, is developed especially to meet the requirements of, for example, public safety organisations (the police, fire department, ambulance service), organisations maintaining public transportation (the metro, railways, airports, taxi service) and those of military user groups. It is a characteristic feature of all these groups of users that they make high reliability and security demands on the communication.

The TETRA system is based on open standards developed by the ETSI (European Telecommunication Standard Institute) and by the TETRA MoU (Memorandum of Understanding) organisation operating in connection therewith.

Thus, the TETRA system is characterized by, among other things, the high demands which its circle of users make on the security of communication taking place by radio way. As the air interface is known to be very vulnerable to all kinds of eavesdropping activities, all modern wireless data communication systems aim in some form at attending to the data security of the air interface. This means safeguarding of the connection between the terminal equipment and the network infrastructure. Inside the network infrastructure the data communication takes place as trusted, because it is extremely improbable that outside intruders could get hold of the physical structure of the system.

The encryption method developed for the TETRA system is primarily used in order to meet two key requirements. The first of these is a strong identification mechanism and the second is air-interface encryption of the radio communication.

In the TETRA system, encryption takes place at the otherwise so vulnerable air interface both of speech and data communication between the terminal equipment and the base transceiver station and also of almost all signalling information and identity verification information of the pieces of terminal equipment. The air-interface encryption is based on an assortment of keys, with which the user and signal information is encrypted over the air interface between the terminal equipment and the TETRA SwMI (Switching and Management Infrastructure), both in personal and group communications. The air-interface encryption supports several renowned standards and manufacturer-specific encryption algorithms.

Assuming that good algorithms and protocols are chosen, the security of every system using encryption is based ultimately on encryption keys and on the methods of their generation, distribution, use and protection. For air-interface encryption, the TETRA system uses several encryption keys, differently from e.g. the GSM system, depending on the available type of connection. Individual, group and DMO operations (Direct Mode Operation) all have encryption keys of their own. The distribution of keys is arranged in the TETRA system to take place in the air-interface encryption by the OTAR method (Over the Air Re-keying), which allows the system a way of re-keying, so that the operation of those in possession of pieces of terminal equipment will not be unduly disturbed by the distribution of keys.

In many cases sufficient confidence in the data transmission results from air-interface encryption without any major additional security arrangements. However, in the TETRA system e.g. certain expert user groups need a very high security level. Examples of such groups are the drug divisions of the police, state crime investigation services and military user groups, which often have an essentially higher security classification established by the state administration than can be provided by the data transmission network using only the conventional air-interface encryption key. Hereby the requirements for additional security concern not only protection of data transmission over the air interface, but also that taking place in the network infrastructure proper from one terminal equipment to another.

These factors lead to additional requirements, for example, in order to achieve anonymity and more advanced confidentiality. In the standards of the TETRA system the need for anonymity is supported in security mechanisms, but the latter requirement is met by end-to-end encryption (e2e), which is used in particular in situations requiring the highest data transmission security through the entire system from a piece of terminal equipment to another piece of terminal equipment.

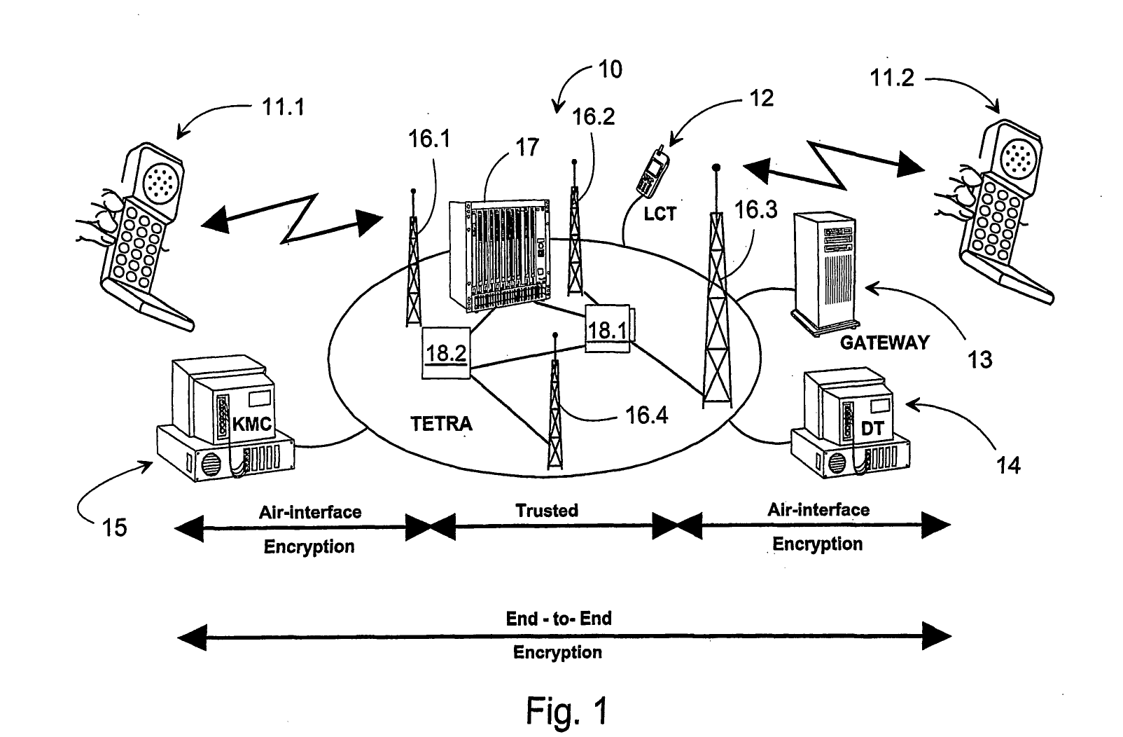

The arrows shown at the bottom of FIG. 1 describe the difference between air-interface encryption and end-to-end encryption in the communication between pieces of terminal equipment.

For example, public security organisations have specific security requirements established high by the state administration for implementing end-to-end encryption, which differ e.g. from the security requirements of military user groups. All such organisations must be able to define their own end-to-end encryption system in accordance with their own requirements.

ETSI's MoU organisation has produced a recommendation (SFPG Recommendation 2), which defines all that is needed for implementation of end-to-end encryption with the exception of the details of encryption algorithms. In the presentation, the algorithms are presented as black boxes. Since the intention is to provide a complete solution also for public groups of users, who do not make especially high requirements as regards the encryption, the recommendation includes an appended proposal for implementation of encryption functions using the known IDEA algorithm (International Data Encryption Algorithm).

However, it is a simple fact that although security functions are integrated in the system, this does not guarantee perfect safety of the system. However, when acting in a known manner, security risks are kept at a minimum in such a way that they are concentrated into certain elements of the system, which can then be supervised at an adequate level.

This supervision is one of the work duties relating to security management. Another duty is to guarantee that the security mechanism is used in a proper manner and that the different mechanisms are integrated in a proper manner in order to achieve an all-covering security system.

In accordance with the state of the art, the air-interface encryption is adequate and problem-free in all respects in the TETRA system. However, despite the above-mentioned facts relating to security, the state of the art has not been able to provide an entirely user group-specific way of implementation to arrange end-to-end encryption. This is a desirable property, for example, in the said expert user groups, where the atmosphere nowadays exists as a general trend that they wish to keep e.g. their encryption keys and their algorithms entirely under their own control, and they do not wish to make over e.g. to manufacturers of terminal equipment any information on the encryption information they use.

In the present-day procedure, e.g. the manufacturers of terminal equipment are strongly involved with encryption-related modules, such as e.g. in the implementation of encryption algorithms and key stream generators. In addition, e.g. updating of encryption algorithms in terminal equipment is nowadays very difficult, if not even impossible, in practice, because as a rule they have been implemented at hardware level statically.

Dynamic implementations for arranging encryption in data transmission are known at least in the PC environment. However, these are usually concerned with data traffic, whereby this technology cannot be utilised in a wireless and voice environment.

U.S. Pat. No. 5,528,693 presents encryption of data communication in speech form. However, this is not dynamic e.g. as regards its management of encryption algorithms, whereby fixed encryption algorithms are always used in the terminal equipment.

U.S. Pat. No. 6,151,677 also presents an encryption model for implementation in wireless terminal equipment. Here the encryption is also arranged in accordance with the state of the art in the manner described above. The encryption algorithms are arranged in the terminal equipment's static memory as firmware, which is then run by the terminal equipment's microprocessor implemented at hardware level. The arrangement here is one, which as regards its whole module implementing the encryption is integrated essentially statically in the terminal equipment. In a solution of this kind the terminal equipment manufacturer, for example, has to commit himself to encryption algorithms selected by the customer, which forms a very disadvantageous situation, for example, from the viewpoint of terminal equipment logistics.

It is a purpose of the present invention to bring about a system of a new kind and a corresponding terminal equipment for arranging end-to-end encryption, which improves essentially the operational prerequisites of the party in need of encryption, that is, the groups of users and the manufacturers of terminal equipment. The characteristic features of the system according to the invention are presented in claim 1 and those of the corresponding terminal equipment are presented in claim 5.

The system according to the invention changes the structure of end-to-end encryption in such a way that a part of the encryption components is externalized, but the encryption proper possibly remains even the same as before. Through the structural change and the externalization the security level of encryption is improved essentially and such an additional advantage is achieved that, for example, the terminal equipment manufacturer need no longer attend to the demands made by user groups as regards the arranging of encryption.

In the system according to the invention, a dynamic processor environment is arranged for the terminal equipment, which can be used to run applications specified for it. In the system, according to an advantageous embodiment, material of the authorities having a high security level is supplied through a data communication network, so that the terminal equipment can carry out the duties assigned for it. Material of this kind may include, for example, end-to-end encryption information, such as encryption applications. The terminal equipment according to the invention provides the services and interfaces required for this implementation.

According to an advantageous embodiment, the processor environment fitted at the terminal equipment may be Java® based and specified according to J2ME (Java 2 Platform Micro Edition).

In a data communication network, which may be based, for example, on FDMA (Frequency Division Multiple Access), TDMA (Time Division Multiple Access), CDMA (Code Division Multiple Access) or on some other wireless technique, a special piece of terminal equipment is arranged, which is used for managing the distribution of encryption information, such as e.g. encryption applications.

The system according to the invention is characterized in that the encryption is carried out at software level at the terminal equipment. Compared with state-of-the-art encryption at hardware level, this achieves dynamic encryption applications for the terminal equipment, whereby it is especially effortless to update the applications.

According to one embodiment, the updating of encryption information can be done in such a way that the user of the terminal equipment need not take any measures in this regard and his activity will not be disturbed in any way due to updating measures.

Another additional advantage of the dynamic application run at the terminal equipment is that it provides a command set e.g. for a processor card at the terminal equipment, with which it can control the terminal equipment by way of the programming interface of the dynamic application.

On the other hand, another advantage of the system according to the invention from the viewpoint of the terminal equipment manufacturer is that no such end-to-end encryption information is stored permanently in the terminal equipment, which is not known to the manufacturer of the terminal equipment.

The other characteristic features of the system according to the invention emerge from the appended claims, and more advantages that can be achieved are listed in the description part.

The system according to the invention, which is not limited to the embodiments to be presented in the following, is explained in greater detail by referring to the appended figures, wherein

FIG. 1 shows air-interface encryption and end-to-end encryption in a data communication network,

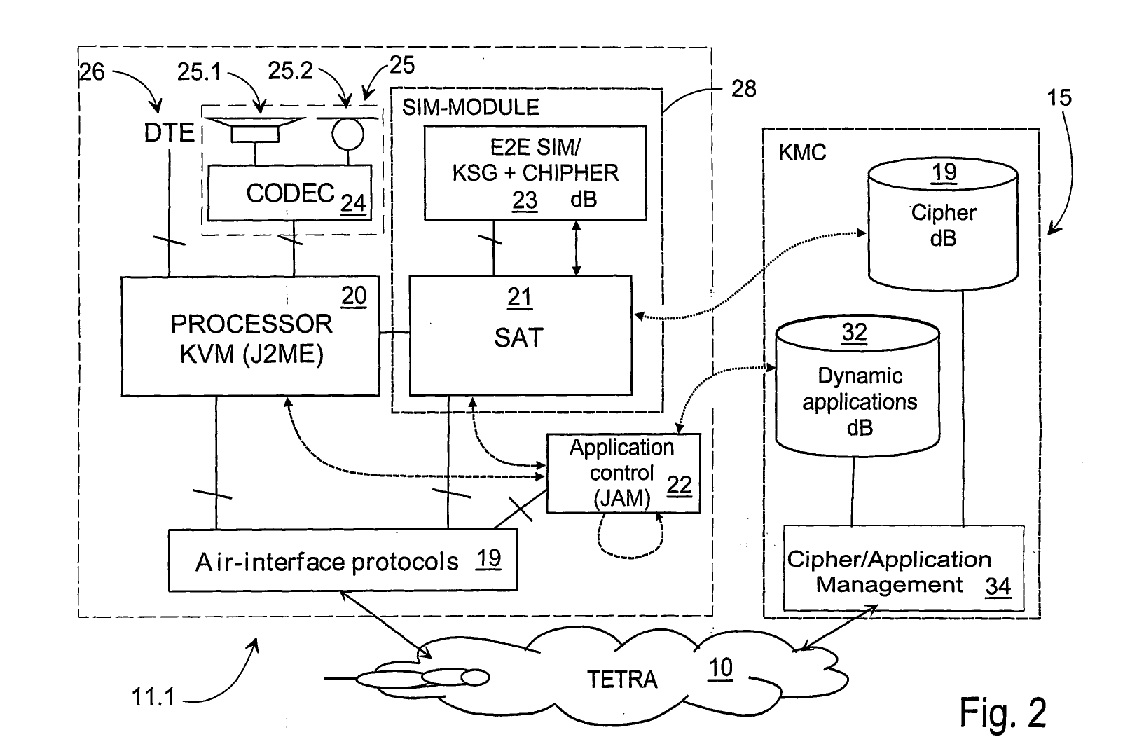

FIG. 2 is a schematic view of an example of terminal equipment and server implementing the system according to the invention,

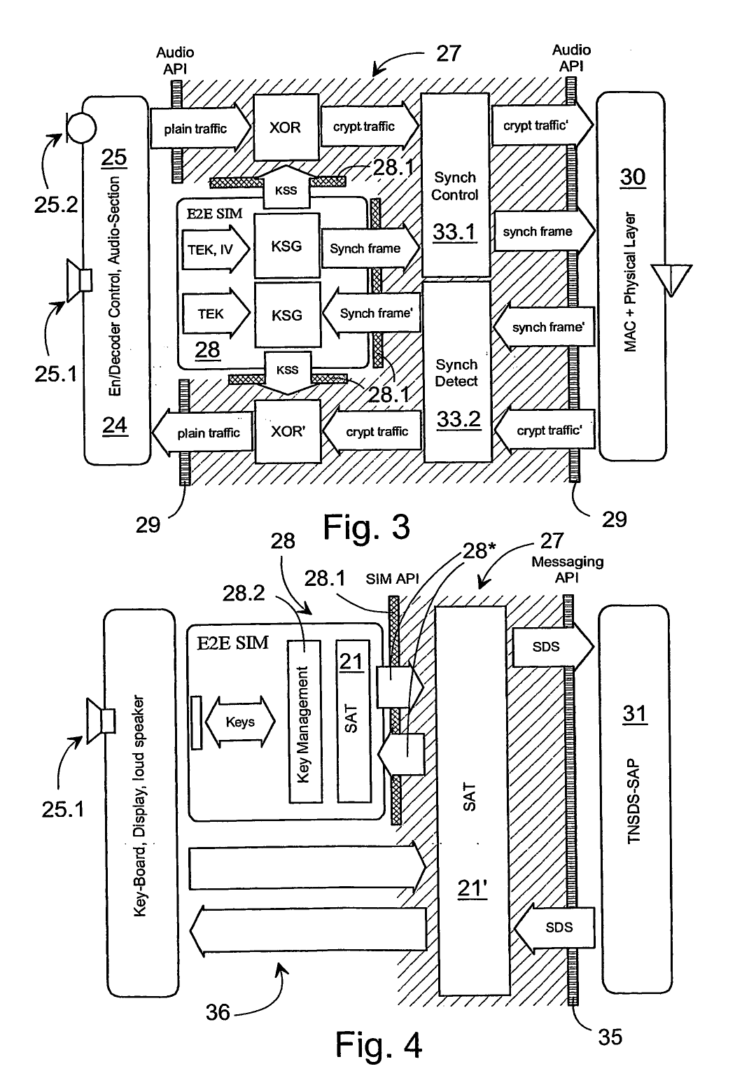

FIG. 3 shows an example of programming interfaces of the system according to the invention in the management of operating parameters, and

FIG. 4 shows an example of programming interfaces of the system according to the invention in the management of the encryption system.

FIG. 1 is a schematic view of the fundamental differences of air-interface encryption and end-to-end encryption in a data communication network, such as, for example, in a digital, wireless network 10 according to the TETRA standard.

It is obvious to the man skilled in the art that although the system according to the invention is described in connection with this application example in a data communication network based on the TETRA infrastructure, the use of the system according to the invention and of the corresponding terminal equipment is not limited to this system explicitly. It can be noted in general terms that the system and the corresponding terminal equipment may be applied generally in digital, wireless network systems, both in those being developed and in existing ones, such as, for example, FDMA, CDMA, TDMA techniques and their subordinated definitions.

In air-interface encryption, the radio signal is relayed encrypted in the data communication network 10 only between the wireless terminal equipment 11.1 and the base transceiver station 16.1 belonging to the infrastructure of data communication network 10 and between base transceiver station 16.3 and the wireless terminal equipment 11.2. In the actual network infrastructure (routers, bridges, repeaters, switching centres and other hardware known to the man skilled in the art) 16.1, 18.2, 17, 18.1, 16.3, the transmission of data taking place is trusted. This means, for example, that outsiders, that is, possibly quarters engaged in espionage, are prevented from getting physical access to the connection of the equipment 17, 18.1, 18.2 forming the network infrastructure 10 and to the data transmission buses between them.

In end-to-end encryption, the signal travels encrypted over the whole distance from the transmitting terminal equipment 11.1 to the terminal equipment 11.2 receiving the transmission. Hereby, the data communication network 10 only does the job of transporting the data.

It must be noted that standards, encryption mechanisms used in air interface encryption, are also used in end-to-end encryption. Air-interface encryption encrypts also the signal, besides speech in between terminal equipment 11.1, 11.2 and infrastructure 10.

Furthermore, besides the mentioned wireless pieces of terminal equipment 11.1, 11.2, various other data transmission equipment may be connected to network 10, such as gateways 13 connecting data communication networks to each other, the operator's work stations DT 14, which are used, for example, to control the formation of user groups and to control their operation, line-connected pieces of terminal equipment LCT 12 and special server terminal devices KMC 15 performing management of encryption parameters and management of encryption in accordance with the system of the invention.

FIG. 2 describes functionalities and the connections between them, which implement an embodiment of the system according to the invention in a wireless terminal equipment 11.1, 11.2 and in a special server terminal device 15 performing encryption management in data communication network 10.

The said special server terminal device 15 can be, for example, a data terminal device, which is connected to the data communication network 10 and in connection with which storing means dB are arranged in order to save at least encryption parameters 19 and applications known as such, especially storing dynamic encryption applications 32. The server terminal device 15 is arranged to have an especially high data security, because it is used to save such information, which is critical for the data communication system.

The said encryption parameters 19 may include, for example, encryption keys which are to be exchanged and relayed to pieces of terminal equipment 11.1, 11.2 at more or less regular intervals using the OTAK (Over the Air Keying) method, encryption control parameters and other such encryption parameters known as such.

In the storing means dB for applications 32 such applications are arranged, which can be transferred to pieces of terminal equipment 11.1, 11.2 by way of the data communication network 10, such as e.g. algorithms used for generation of an encryption key flow or for encryption of the actual dataflow. According to an advantageous embodiment, the applications 32 may be JAVA® applications, especially in accordance with the J2ME (Java 2 Platform Micro Edition) specification. Other application forms, such as a pure native code which can be carried out without interpretation, Chet, C#, BREW are also suitable for use.

At the special server terminal device 15 a management functionality 34 is also arranged, which is used for management of encryption parameters and applications 19, 32 and for controlling their distribution to pieces of terminal equipment 11.1, 11.2 in accordance with the established criterion.

It should be noticed that the terminal device 15 providing server functionality can be implemented with any terminal of those in the TETRA network 10, if resources are arranged for these for management and distribution of encryption keys and applications 19, 32. This being the case, the server terminal device 15 managing the applications may also be separate, for example, from the terminal device managing and distributing encryption keys 19.

When terminal equipment 11.1, 11.2 is connected through an air-interface protocol 19 of a kind known as such to data communication network 10, it can receive the said encryption parameters and applications 19, 32 from server terminal device 15 using the chosen transfer channel and advantageously using the chosen manner of encryption, the use of which need not necessarily be permanently determined.

An advantageous example of such a way of distribution used as transfer channel in the TETRA network 10 according to the example are the encrypted SDS messages. SDS (Short Data Service) is a message of the short message type, which is relayed through terminal equipment 11.1, 11.2 directly to the processor card arranged in connection with it, such as e.g. to a SIM (Subscriber Identity Module) module, in such a way that terminal equipment 11.1, 11.2 does not interpret the message in any way. Other examples of transfer channels for use in the measure are SMS (Short Message System) messages, GSM data and GPRS transmission.

Downloading of applications 32 in pieces of terminal equipment 11.1, 11.2 can also be performed locally. This takes place, for example, in such a way that the terminal equipment 11.1, 11.2 receiving encryption information 19, 32 is in a fixed connection with the said server terminal device 15, from which encryption information and applications 19, 20 are then transferred, for example, in serial traffic form, along an IrDA (Infrared Data) connection, Bluetooth connection or some other bus, which is advantageous for the terminal equipment 11.1, 11.2 (not shown).

In the system according to the invention, such a functionality is arranged in connection with the terminal equipment 11.1, 11.2, which allows, for example, flexible processing of information and which according to an advantageous embodiment can be implemented e.g. with a SIM module 28. In an e2e partition 23 arranged in the memory means of SIM module 28, those encryption keys and applications 19, 32 are stored, which are downloaded and decrypted from server terminal device 15, such as, for example, the key stream generator.

For these measures, a SAT partition 21 (SIM Application Toolkit) is arranged in connection with the SIM module 28. The SAT partition 21 provides a mechanism in between the terminal equipment 11.1, 11.2 and the SIM module 28, which allows an application arranged at the SIM module 28 to interact and control the operation of terminal equipment 11.1, 11.2, provided that the terminal equipment 11.1, 11.2 supports the SAT mechanism. Using the command library of SAT partition 21 reception of encryption keys and applications 19, 32 is carried out in the system according to the invention as well as decryption of their encryption and storing them at the SIM module 28 to the e2e partition 23.

Besides the smooth updating measures, the command library of SAT partition 21 can be used for an effective management of the said encryption data and for controlling the encryption functionality, which is arranged from SIM module 28 to terminal equipment 11.1, 11.2 and which will be described later. SAT partition 21 requires SAT compatibility with terminal equipment 11.1, 11.2, whereby the said applications arranged at the SIM module 28 must be in a form which terminal equipment 11.1, 11.2 can understand, whereas terminal equipment 11.1, 11.2 must be able to execute the commands given to it by the applications.

Updating of the encryption keys 19 and the applications 32 used in the encryption (key stream generator, KSG) is thus performed for the SIM module 28 of terminal equipment 11.1, 11.2 in an embodiment of the invention. The software environment of the SIM module 28 may be based, for example, on the J2ME specification, which is compatible with the SAT software interface.

Furthermore, the features provided by the SAT partition 21 of the SIM module 28 include the possibility to utilise in terminal equipment 11.1, 11.2 the multi-level menus stored at the SIM module 23 as well as the simple applications or functions arranged behind them.

In the system according to the invention, application management 22 is further arranged at the terminal equipment 11.1, 11.2. According to an advantageous embodiment, this can be implemented, for example, with JAM (Java Application Management). Its duty is to function as an interface between the terminal equipment's 11.1, 11.2 RTOS (Real Time Operating System), the SAT partition 21 arranged at the SIM module 28 and allowing the application commanding the terminal equipment 11.1, 11.2 and the KVM, that is, the Java® virtual processor 20. The JAM 22 is used to control the stack of applications 32 downloaded at the terminal equipment 11.1, 11.2 and their downloading at the virtual processor KVM 20.

Thus, on the RTOS of terminal equipment 11.1, 11.2 a Java® virtual processor KVM 20 (Kilobyte Java Virtual Machine), for example, is run, which is preferably in accordance with the J2ME specification (Java 2 Platform Micro Edition). Hereby the processor 20 is preferably configured in accordance with the MIDP specification (Mobile Information Device Profile), whereby the KVM 20 will need only a minimum number of class libraries and necessary APIs (Application Protocol Interface). JAM 22 attends to the interface function together with SAT partition 21 of the SIM module 28, that is, its duty is on behalf of the KVM 20 to control the storing, fetching and returning of encryption applications 32 in between the memory means of terminal equipment 11.1, 11.2, the e2e partition 23 of the SIM module 28 and the KVM 20. In addition, JAM 22 is used to control the downloading of Java® applications, that is, MIDdlets from the data communication network 10 (dotted arrow).

The user level of terminal equipment 11.1, 11.2 has an analog audio section 25 of a kind known as such, which includes at least microphone means 25.2 for receiving the user's speech and loudspeaker means 25.1 for listening to the transmission received by terminal equipment 11.1, 11.2. The audio signal undergoes AD conversion (encoding) in a manner known as such in speech codec 24 located in the digital section of audio section 25, which will result in a dataflow to be encrypted. Correspondingly, when receiving a transmission, the dataflow decrypted from encryption will undergo in speech codec 24 DA conversion (decoding), so that through loudspeaker means 25.1 it can be listened to and understood by the user of terminal equipment 11.1, 11.2.

Furthermore, the terminal equipment 11.1, 11.2 includes a connection interface for external data terminal equipment (DTE) 26, which can be used for downloading encryption information, such as keys and applications, in the terminal equipment 11.1, 11.2 from the server terminal device 15 or such without any connection with the actual data communication network 10.

FIG. 3 is a schematic view of an advantageous manner of implementation of the system according to the invention in the control of operating parameters as an interface description. The cross-lined area of the figure shows a part implemented as Java®-MIDdlet 27, which is thus run with KVM 20 dynamically on the RTOS of the terminal equipment. The operation of MIDdlet 27 is described in the following first from the viewpoint of the traffic to be transmitted and then from the viewpoint of the traffic to be received.

In the application example, two functional API interfaces are arranged in connection with MIDdlet 27. The first interface is audio API 29, behind which an audio section 25 is arranged in the user interface (a microphone 25.2, a loudspeaker 25.1, among other things), as well as a speech codec 24 and other functionality, which is obvious to the man skilled in the art and which is not shown in the figure. In the API definition, what is essential from the viewpoint of the invention is the plain data traffic arriving from codec 24 to MIDdlet 27 and departing from MIDdlet 27 to codec 24.

In the system according to the invention, the AD converted dataflow (plain traffic) is thus captured from the user-level audio API 29 and supplied for processing to the Java®-MIDdlet encryption application 27 run by the terminal equipment's 11.1, 11.2 processor, that is, the KVM 20. The application 27 executes, for example, a XOR operation or some other chosen encryption application, which is brought to the terminal equipment 11.1, 11.2 in accordance with the system of the invention.

The other interface to Java® MIDdlet 27 is SIM API 28.1, behind which is shown the functionalities of the SIM module's 28 e2e partition 23, which are essential for the invention, and the encryption parameters to be kept therein. The key stream generator KSG to be run in the SIM module's 28 e2e partition 23 is given as input the TEK (Traffic Encryption Key) when encrypting data traffic and the numerical value IV (Initialization Vector) for carrying out synchronization of the encryption.

The encryption key is supplied by server terminal device 15 to terminal equipment 11.1, 11.2 and the IV is generated at terminal equipment 11.1, 11.2 according to the known technology. Key stream generator KSG produces a key stream segment, which is guided by way of SIM API 28.1 to MIDdlet 27 for the encryption application XOR. In addition, the key stream generator KSG produces a synchronization frame (Synch frame), which is given through SIM API 28.1 to the synchronization functionality 33.1 (Synch Control) brought about by MIDdlet 27.

A serial port API is another alternative way of implementing the SIM interface 28.1. Hereby such an encryption module is fitted in the outer connection interface of terminal equipment 11.1, 11.2, which may be e.g. in connection with its battery. Hereby the management information of key stream generator KSG may be addressed to the connection interface in question. Furthermore, the key stream segment produced by the encryption module can also be read from the external connection interface for XOR and/or XOR′ operations.

Furthermore, the terminal equipment 11.1, 11.2 may also be implemented in such a way that no encryption module providing encryption functionality is connected to its outer interface (for example, a serial port API) and the terminal equipment 11.1, 11.2 does not either include any SIM module 28. In this case, the end-to-end encryption functionality according to the invention can be implemented in such a way that in the application example described above the encryption functionality 23 arranged at the SIM module 28 is also implemented as an application to be downloaded. Hereby the security of the terminal equipment 11.1, 11.2 must be especially ensured.

The dataflow encrypted by the XOR operation is supplied further to the synchronization control (Synch Control) performed by MIDdlet 27. This is used to perform functions known as such with the dataflow. From Synch Control the encrypted dataflow (crypt traffic′) and the synchronization frame (synch frame) exit from the MIDdlet through the audio API 29 interface to the MAC (Medium Access Control) layer and further to the physical layer 30.

In the MAC layer, radio frequencies and time slots are managed and frames are stolen for synchronization. In the physical layer, steps known as such are taken, such as, for example, coding and decoding of the dataflow (air-interface encryption/decryption) and further transmission/reception. Further, the encrypted data is transmitted to the data communication network 10, where it is transferred in an end-to-end manner known as such in terms of encryption technology to the receiving terminal equipment 11.2. If stealing of frames is done in the Synch Control, then no synch frame, synch frame′ interfaces are needed.

The synchronization of the encrypted dataflow to be transmitted and received is arranged with memory means of the terminal equipment 11.1, 11.2 either buffered or another method is to do it with a flow control protocol. This is done to make sure that the packets to be transferred from terminal equipment 11.1, 11.2 to network 10 and from network 10 to terminal equipment 11.1, 11.2 (uplink/downlink traffic) are in the correct order and time.

When the terminal equipment 11.1 receives e2e transmission, the encrypted data (crypt traffic′) and the synchronization frame (synch frame′) are received in MIDdlet 27 through the audio API 29 interface from the physical layer 30 of the terminal equipment 11.1. The synchronization of the dataflow is desynchronized by a functionality (Synch Detect) 33.2, which is arranged for the purpose in MIDdlet 27. Based on the synchronization, the decryption key and algorithm to be used are chosen.

The encrypted dataflow (crypt traffic) is guided to the algorithm performing the inverted function XOR′ of the XOR operation, and the key stream segment KSS needed for decryption of the encryption is obtained, for example, from the encryption key stream generator KSG of the e2e partition 23 of SIM module 28, which generator receives as input TEK and the Synch frame′ received from Synch Detect 33.2. Further, the decrypted dataflow (plain traffic) is guided through audio API 29 to audio section 25 of terminal equipment 11.1 and after known intermediate stages (DA conversion, among others) it is turned into a form, which the user will understand and which is to be listened to with the aid of loudspeaker means 25.1.

FIG. 4 shows an example of the programming interfaces of the system according to the invention in connection with management of the encryption system. Key management 28.2 and SAT 21 are arranged at the SIM module's 28 e2e partition 23. The interface provided by the terminal equipment's 11.1, 11.2 SIM module 28 may be connected to the public user interface of the MIDP of MIDdlet 27. Hereby the MIDdlet 27 to be downloaded implements such an interface for the SIM module 28, through which this can control the operation of terminal equipment 11.1, 11.2. Hereby the SAT functions are thus converted into MIDP-API functions.

The SIM module's 28 e2e partition 23 is connected through SIM API 28.1 with the SAT 21 implemented in Java® MIDdlet 27. SAT 21′ of MIDdlet 27 is connected through the Messaging API interface 35 with TNSDS-SAP 31 (TETRA SDS Service Access Point). The TNSDS-SAP 31 is a protocol by which user applications are allowed to utilise the SDS transfer bearer. Data transmission and reception may be performed both as SDS and as SMS (Short Message Service), as in GSM.

According to an advantageous embodiment, the application 27 downloaded at terminal equipment 11.1, 11.2 may besides implementing an interface for the SIM module 28 also independently control the operation of terminal equipment 11.1, 11.2 by way of the programming interface 36. Hereby the application 27 downloaded at terminal equipment 11.1, 11.2 will allow SAT functionality 21′ for the terminal equipment, using the programming interface 36 (MIDP-API) existing at the terminal equipment 11.1, 11.2. This feature is very useful generally, and this being the case it is not only end-to-end encryption-specific in any way.

If the SDS data to be transmitted to terminal equipment 11.1, 11.2 is, for example, encryption keys or applications, then the SAT 21′ of MIDdlet 27 will process and guide these to the SIM module 28 through the message protocol 28* of SIM API 28.1. At the SIM module 28 the said encryption information is processed in the way described above.

If the information arriving through the SDS carrier is, for example, pictures, games, animations, sounds or other such information, then these are guided directly along MIDP's ordinary API 36 from SAT 21′ implemented from MIDdlet 27 to the terminal equipment's 11.1, 11.2 user interface, which includes, for example, a keyboard, a display and a loudspeaker 25.1.

Thus, the terminal equipment 11.1, 11.2 is used to run a dynamic virtual processor KVM 20, where when the end-to-end encryption is active its implementing MIDdlet 27 is run by the dynamic virtual processor 20. If the user of the terminal equipment 11.1, 11.2 wishes to activate some other Java® application, then performance of the encryption application is stopped, and a notification to the user then follows. The encryption application may possibly also be run in a background mode, if allowed by the resources of the terminal equipment 11.1, 11.2 and the virtual processor.

At the user interface the Middlet encryption application 27 can be implemented in such a way that it is always active or, alternatively, it can be activated separately by the user. When the application 27 is set to be active at all times, its activation will take place automatically as the terminal equipment 11.1, 11.2 is turned on. In the terminal equipment 11.1, 11.2 there may be one or more applications, whereby they will need some kind of separator to separate them from any other applications.

The manner of implementation chosen by the user is known, for example, from the GSM terminal equipment. There the user may activate the application of his choice in a Java application menu. The printouts of the Middlet application (menus, graphic elements etc.) are preferably presented, for example, as a submenu, because they may otherwise cause confusion at the proper user interface UI of the terminal equipment. At a normal user interface it is possible to present, for example, an icon, through which access is possible to the MIDdlet application menu.

Applications which can be run may also be classified according to different criteria. Hereby special rights may be established, for example, for the encryption application according to the invention.

The system according to the invention provides the groups of users of terminal equipment 11.1, 11.2 with a significant improvement of the security features of encryption information. For example, the group of users may exchange keys for longer ones according to their personal needs, which may be used significantly to increase the security of the encryption.

It should be understood that the above explanation and the relating figures are only intended to illustrate the system according to the present invention. Thus, the invention is not limited only to the embodiments presented above or to those defined in the claims, but many such different variations and modifications of the invention will be obvious to the man skilled in the art, which are possible within the inventive idea defined in the appended claims.

1. System in a digital wireless data communication network for arranging end-to-end (e2e) encryption, especially for communication in audio form, in which data communication network two or more pieces of terminal equipment communicate with one another, including at least
a codec to convert an audio signal into a dataflow and vice versa,
air-interface encryption means,
means for management of encryption parameters stored in connection with the terminal equipment)
an encryption key stream generator KSG to generate a key stream segment (KSS) with the said encryption parameters
means for encrypting a dataflow and for decryption of the encryption with the generated key stream segment,
means for synchronization of the encrypted dataflow and for de-synchronizing the synchronization, and
at least one interface for receiving the encryption parameters from the data communication network,
and wherein at least one of the pieces of terminal equipment belonging to the data communication network is fitted to function as a special server terminal device, which manages and distributes at least the encryption parameters concerning the data communication network to the other pieces of terminal equipment based on an established criterion, characterized in that
in the data communication network a special server terminal device is also arranged, which is arranged to manage at least encryption and/or synchronization applications and to distribute these based on an established criterion to the other pieces of terminal equipment and
functionalities are arranged in the terminal equipment for downloading and managing the said applications and
data memory for storing the applications and
a processor and operating memory for carrying out the applications.

2. System according to claim 1, characterized in that the terminal equipment is adapted with the said processor to run applications according to the J2ME (Java 2 Platform Micro Edition) specification.

3. System according to claim 2, characterized in that the terminal equipment is configured in accordance with the MIDP (Mobile Information Device Profile) specification.

4. System according to any one of claims 1, characterized in that downloading of applications at the terminal equipment is arranged to take place in a self-organizing manner, such as, for example, as SDS (Short Data Service) messages.

5. Digital wireless terminal equipment, to which functionalities belong, at least
a module for carrying out encryption,
one or more modules for carrying out synchronization, and
a module for receiving and managing at least encryption keys,
characterized in that the functionality of at least one module is adapted for implementation with a dynamic application based on a program.

6. Terminal equipment according to claim 5, including at least a SIM module, characterized in that the said application is adapted to arrange command functionality at least at the interface between the SIM module and the terminal equipment through the programming interface (MIDP API) of the application.
